(19) United States
(12) Patent Application Publication
(10) Pub. No.: US 2016/0348837 A1
(43) Pub. Date: Dec. 1, 2016

(54) PROJECTION DEVICE AND HANGER SUPPORT THEREOF

(71) Applicant: Li-Jen Liu, Taipei City (TW)

(72) Inventors: Li-Jen Liu, Taipei City (TW); Pei-Jung Tsai, Taipei City (TW)

(21) Appl. No.: 15/162,811

(22) Filed: May 24, 2016

(30) Foreign Application Priority Data
May 26, 2015 (TW) 104208113
Aug. 31, 2015 (TW) 104214077

(51) Int. Cl. F16M 13/02; F16M 11/20; H04N 9/31; F16M 11/14

(52) U.S. Cl. CPC F16M 13/027; F16M 11/14; F16M 11/2014; H04N 9/3147; H04N 9/3141

(57) ABSTRACT

A projection device includes a hanger support and a projector connected to the hanger support and configured to project audio/video/image contents. The hanger support includes a coupling portion, a supporting arm, and a main body. The coupling portion is configured to connect to a track for receiving power from the track. The supporting arm is connected to the coupling portion. The main body is connected to the supporting arm.

### BACKGROUND OF THE INVENTION

Field of the Invention

The invention relates to a projection device and a hanger support thereof, and more particularly to a projection device and a hanger support thereof, having a coupling portion for connection to a track.

Description of the Related Art

Projection devices can be installed in different ways for use. An example of installation is to suspend a projection device from a ceiling, wherein a hanger support fixed to the ceiling in advance and a power outlet mounted on the ceiling for the projection device to use are required. Although a projection device suspended from a ceiling occupies reduced space, the installation of the projection device is complicated and inconvenient. Besides, the power outlet and the power cable create an adverse visual impact on the ceiling. Generally, an image projected by the conventional projection device is rectangular and has a horizontal side longer than a vertical side. On some occasions, however, an image projected by the conventional projection device having a horizontal side shorter than a vertical side is required. Therefore, a conventional projection device and the hanger support thereof fail to meet all the requirements.

### BRIEF SUMMARY OF THE INVENTION

The invention provides a projection device and a hanger support thereof to solve the described problems. The projection device of the invention is configured to be connected to a track which is capable of providing power for a track light. By this arrangement, the power required by the projection device is also provided by the track. It is not necessary to change the existing cable arrangement and space design in the ceiling in the installation of the projection device. Therefore, the installation of a projection device is significantly simplified. Also, the application of a projection device is diversified. The projection device is able to project a rectangular image having a horizontal side longer or shorter than a vertical side, in accordance with the use situations or requirements.

The hanger support in accordance with an exemplary embodiment of the invention includes a coupling portion, a supporting arm, and a main body. The coupling portion is configured to connect to a track for receiving power from the track. The supporting arm is connected to the coupling portion. The main body is connected to the supporting arm.

In another exemplary embodiment, the hanger support further includes a first rotatable element connected to the coupling portion wherein the first rotatable element comprises a reception hole connected to the supporting arm, and the first rotatable element is rotatable to rotate the supporting arm, move the main body, and change a position of the main body.

In yet another exemplary embodiment, the hanger support further includes a second rotatable element connected to the supporting arm and the main body wherein the second rotatable element is rotatable to move the main body and change a position of the main body.

In another exemplary embodiment, the hanger support further includes a reflector connected to the main body.

In yet another exemplary embodiment, the hanger support further includes a third rotatable element and a reflector wherein the third rotatable element connected to the main body and the reflector, and the third rotatable element is rotatable to adjust a position of the reflector.

In another exemplary embodiment, the hanger support further includes an AC-DC converter disposed in the coupling portion, wherein the power from the track is AC power and the AC-DC converter is configured to convert the AC power to DC power.

In yet another exemplary embodiment, the hanger support further includes an AC-DC converter disposed in the main body, wherein the power from the track is AC power and the AC-DC converter is configured to convert the AC power to DC power.

In another exemplary embodiment, the hanger support further includes a housing connected to the main body.

In yet another exemplary embodiment, the hanger support further includes a first rotatable element, a second rotatable element, a third rotatable element, a reflector, an AC-DC converter, a housing, and a light source. The first rotatable element is connected to the coupling portion wherein the first rotatable element comprises a reception hole connected to the supporting arm, and the first rotatable element is rotatable to rotate the supporting arm, move the main body, and change a position of the main body. The second rotatable element is connected to the supporting arm and the main body wherein the second rotatable element is rotatable to move the main body and change the position of the main body. The third rotatable element is connected to the main body. The reflector is connected to the third rotatable element, wherein the third rotatable element is rotatable to adjust a position of the reflector. The AC-DC converter is disposed in the coupling portion, wherein the power from the track is AC power and the AC-DC converter is configured to convert the AC power to DC power. The housing is connected to the main body. The light source is connected to the housing.

The invention also provides a projection device. The projection device in accordance with an exemplary embodiment of the invention includes the above hanger support and a projector connected to the hanger support and configured to project audio/video/image contents.

In another exemplary embodiment, the projection device further includes a receiver and a multimedia capturing device connected to the projector, wherein the receiver is configured to receive a multimedia signal, the projector is configured to project audio/video/image contents of the multimedia signal, and the multimedia capturing device is configured to record a surrounding video, image and sound and transmit the recorded surrounding video, image and sound to a far-end device via a cable network or a wireless network.

In yet another exemplary embodiment, the hanger support further includes a balance arm connected to the coupling portion.

In another exemplary embodiment, the hanger support further includes a first rotatable element, a top mount, a second rotatable element, a third rotatable element, a reflector, an AC-DC converter, and a housing. The first rotatable element is connected to the coupling portion wherein the first rotatable element comprises two reception holes connected to the supporting arm and the balance arm, and the first rotatable element is rotatable to rotate the supporting arm and the balance arm, move the main body, and change a position of the main body. The top mount is connected to the balance arm and configured to be rotated to adjust a length of the top mount protruding from the balance arm. The second rotatable element is connected to the supporting arm and the main body wherein the second rotatable element is rotatable to move the main body and change the position of the main body. The third rotatable element is connected to the main body. The reflector is connected to the third rotatable element, wherein the third rotatable element is rotatable to adjust a position of the reflector. The AC-DC converter is disposed in the coupling portion, wherein the power from the track is AC power and the AC-DC converter is configured to convert the AC power to DC power. The housing is connected to the main body.

In yet another exemplary embodiment, the hanger support includes a coupling portion, a first rotatable element, an engaging assembly, and a main body. The coupling portion is configured to connect to a track for receiving power from the track. The main body includes a top groove, a right groove, a left groove, and a rear groove, all of which comprise curved bottoms. The first rotatable element is connected to the coupling portion and the engaging assembly. The engaging assembly is connected to one of the top groove, the right groove, the left groove, and the rear groove. The engaging assembly is configured to slide along the top groove when connected to the top groove. The engaging assembly is configured to slide along the right groove when connected to the right groove. The engaging assembly is configured to slide along the left groove when connected to the left groove. The engaging assembly is configured to slide along the rear groove when connected to the rear groove. The first rotatable element is rotatable to rotate the main body.

In another exemplary embodiment, the hanger support includes a coupling portion, a first rotatable element, a supporting arm, a second rotatable element, an engaging assembly, and a main body. The coupling portion is configured to connect to a track for receiving power from the track. The first rotatable element is connected to the coupling element. The supporting arm is connected to the first rotatable element. The second rotatable element is connected to the supporting arm. The engaging assembly is connected to the second rotatable element. The main body includes a top groove, a right groove, a left groove, and a rear groove, all of which comprise curved bottoms. The engaging assembly is connected to one of the top groove, the right groove, the left groove, and the rear groove. The engaging assembly is configured to slide along the top groove when connected to the top groove. The engaging assembly is configured to slide along the right groove when connected to the right groove. The engaging assembly is configured to slide along the left groove when connected to the left groove. The engaging assembly is configured to slide along the rear groove when connected to the rear groove. The first rotatable element is rotatable to rotate the main body. The second rotatable element is rotatable to rotate the main body.

In yet another exemplary embodiment, the hanger support further includes a balance arm and a top mount wherein the top mount connects to the balance arm, the top mount is configured to be rotated to adjust a length of the top mount protruding from the balance arm, and the first rotatable element comprises two reception holes connected to the supporting arm and the balance arm.

In another exemplary embodiment, the projection device includes the above hanger support and a projector connected to the hanger support and configured to project audio/video/image contents.

In yet another exemplary embodiment, the projection device further includes a receiver and a multimedia capturing device connected to the projector, wherein the receiver is configured to receive a multimedia signal, the projector is configured to project audio/video/image contents of the multimedia signal, and the multimedia capturing device is configured to record a surrounding video, image and sound and transmit the recorded surrounding video, image and sound to a far-end device via a cable network or a wireless network.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 depicts a hanger support in accordance with a first embodiment of the invention;

FIG. 2 depicts a hanger support in accordance with a second embodiment of the invention;

FIG. 3 depicts a hanger support in accordance with a third embodiment of the invention;

FIG. 4 depicts a hanger support in accordance with a fourth embodiment of the invention;

FIG. 5 depicts a hanger support in accordance with a fifth embodiment of the invention;

FIG. 6 depicts a hanger support in accordance with a sixth embodiment of the invention;

FIG. 7 depicts a projection device in accordance with a first embodiment of the invention;

FIG. 8 depicts a projection device in accordance with a second embodiment of the invention;

FIG. 9A depicts a first rotatable element of a hanger support in accordance with an embodiment of the invention;

FIG. 9B depicts a first rotatable element of a hanger support in accordance with another embodiment of the invention;

FIG. 10 depicts a projection device in accordance with a third embodiment of the invention;

FIG. 11 depicts a hanger support in accordance with a seventh embodiment of the invention;

FIG. 12 depicts a projection device in accordance with a fourth embodiment of the invention;

FIG. 13 depicts a hanger support in accordance with an eighth embodiment of the invention;

FIG. 14 depicts a hanger support in accordance with a ninth embodiment of the invention;

FIG. 15 depicts a projection device in accordance with a fifth embodiment of the invention;

FIG. 16 depicts a projection device in accordance with a sixth embodiment of the invention;

FIG. 17 depicts a projection device in accordance with a seventh embodiment of the invention;

FIG. 18 depicts a projection device in accordance with an eighth embodiment of the invention; and

FIG. 19 depicts a projection device in accordance with a ninth embodiment of the invention.

### DETAILED DESCRIPTION OF THE INVENTION

Some commercial spaces are provided with track lights for projecting light to target objects. The target objects may be wall pictures, poster billboards, floor sculptures, etc. Generally, a track light is connected to a track and the track is connected to or suspended from a ceiling for providing the track light with power. In the invention, a projection device is connected to a track of a track light, receives power from the track, and projects audio/video/image contents. Where the audio/video/image contents are projected can be adjusted by a hanger support.

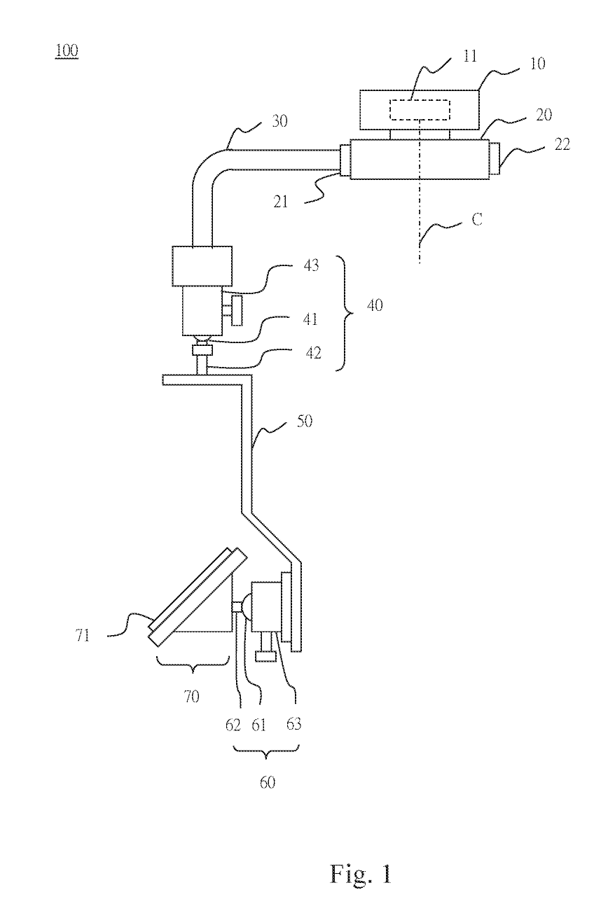

FIG. 1 depicts a hanger support in accordance with a first embodiment of the invention, wherein the hanger support 100 includes a coupling portion 10, an alternating current to direct current converter (hereinafter AC-DC converter) 11, a first rotatable element 20, a supporting arm 30, a second rotatable element 40, a main body 50, a third rotatable element 60, a reflector mount 70, and a reflector 71. The first rotatable element 20 includes reception holes 21 and 22. The second rotatable element 40 (for example, a cradle head of a tripod or a ball-and-socket joint) includes a ball 41, a stud 42, and a socket 43. The third rotatable element 60 (for example, a cradle head of a tripod or a ball-and-socket joint) includes a ball 61, a stud 62, and a socket 63. The AC-DC converter 11 is disposed in the coupling portion 10. The first rotatable element 20 is connected to the coupling portion 10. The supporting arm 30 has two ends respectively connected to the reception hole 21 and the second rotatable element 40. The second rotatable element 40 is connected to the main body 50. The reflector 71 is disposed on the reflector mount 70. The reflector mount 70 is connected to the third rotatable element 60. The third rotatable element 60 is connected to the main body 50.

To use the hanger support 100, the coupling portion 10 is connected to a track (not shown) which is, for example, the track of a track light fixed to or suspended from a ceiling in advance. The hanger support 100 is movable along the track (not shown) to change the location thereof in three-dimensional space in accordance with the requirements. The track (not shown) is capable of providing AC power. Thus, the coupling portion 10 is capable of receiving AC power from the track (not shown) through a connection of the coupling portion 10 to the track (not shown). In operation, the coupling portion 10 receives AC power from the track (not shown) and the AC power is converted to DC power by the AC-DC converter 11 disposed in the coupling portion 10 for other devices to use. The first rotatable element 20 is rotatable about an axis C to rotate the supporting arm 30, move the main body 50, and change the position of the main body 50 in three-dimensional space. The ball 41 can be rotated with respect to the socket 43 to rotate the stud 42. Therefore, the main body 50 connected to the stud 42 can be rotated in three-dimensional space by means of rotation of the ball 41. The ball 61 can be rotated with respect to the socket 63 to rotate the stud 62. Therefore, the reflector mount 70 connected to the stud 62 can be rotated in three-dimensional space, by means of rotation of the ball 61, to rotate the reflector 71.

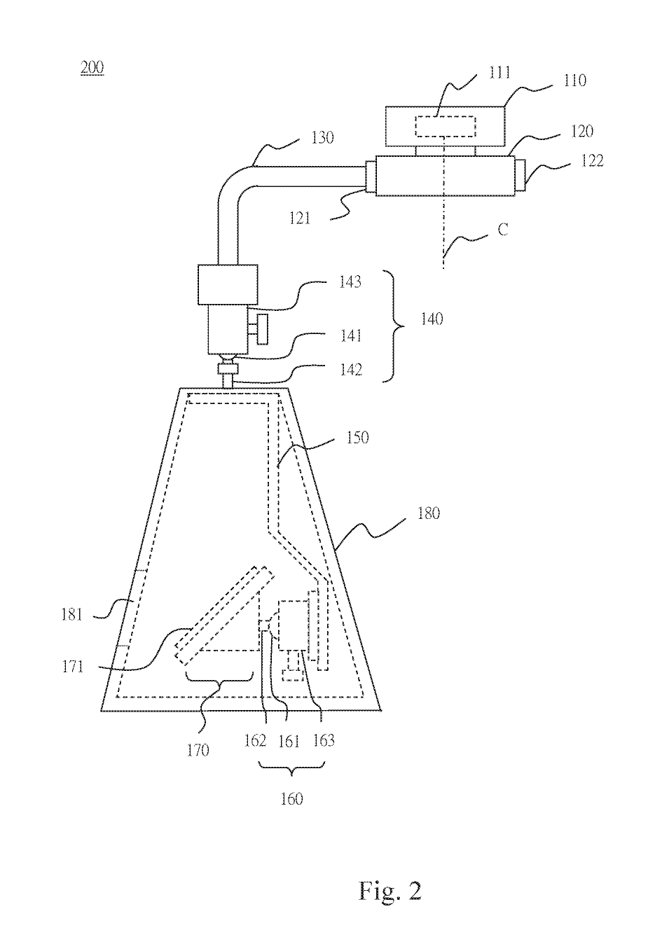

FIG. 2 depicts a hanger support in accordance with a second embodiment of the invention, wherein the hanger support 200 includes a coupling portion 110, an AC-DC converter 111, a first rotatable element 120, a supporting arm 130, a second rotatable element 140, a main body 150, a third rotatable element 160, a reflector mount 170, a reflector 171, and a housing 180. The first rotatable element 120 includes reception holes 121 and 122. The second rotatable element 140 (for example, a cradle head of a tripod or a ball-and-socket joint) includes a ball 141, a stud 142, and a socket 143. The third rotatable element 160 (for example, a cradle head of a tripod or a ball-and-socket joint) includes a ball 161, a stud 162, and a socket 163. The housing 180 has an opening 181. The AC-DC converter 111 is disposed in the coupling portion 110. The first rotatable element 120 is connected to the coupling portion 110. The supporting arm 130 has two ends respectively connected to the reception hole 121 and the second rotatable element 140. The second rotatable element 140 is connected to the main body 150. The reflector 171 is disposed on the reflector mount 170. The reflector mount 170 is connected to the third rotatable element 160. The third rotatable element 160 is connected to the main body 150. The housing 180 houses the main body 150.

To use the hanger support 200, the coupling portion 110 is connected to a track (not shown) which is, for example, the track of a track light fixed to or suspended from a ceiling in advance. The hanger support 200 is movable along the track (not shown) to change the location thereof in three-dimensional space in accordance with the requirements. The track (not shown) is capable of providing AC power. Thus, the coupling portion 110 is capable of receiving AC power from the track (not shown) through a connection of the coupling portion 110 to the track (not shown). In operation, the coupling portion 110 receives the AC power from the track (not shown) and the AC power is converted to DC power by the AC-DC converter 111 disposed in the coupling portion 110 for other devices to use. The first rotatable element 120 is rotatable about an axis C to rotate the supporting arm 130, move the main body 150, and change the position of the main body 150 in three-dimensional space. The ball 141 can be rotated with respect to the socket 143 to rotate the stud 142. Therefore, the main body 150 connected to the stud 142 can be rotated in three-dimensional space by means of rotation of the ball 141. The ball 161 can be rotated with respect to the socket 163 to rotate the stud 162. Therefore, the reflector mount 170 connected to the stud 162 can be rotated in three-dimensional space, by means of rotation of the stud 162, to rotate the reflector 171.

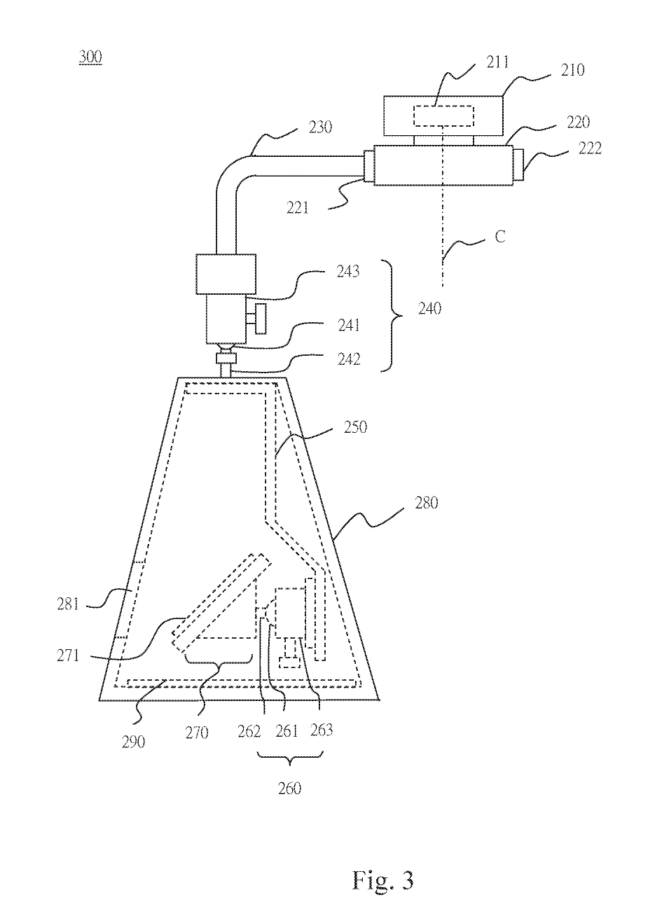

FIG. 3 depicts a hanger support in accordance with a third embodiment of the invention, wherein the hanger support 300 includes a coupling portion 210, an AC-DC converter 211, a first rotatable element 220, a supporting arm 230, a second rotatable element 240, a main body 250, a third rotatable element 260, a reflector mount 270, a reflector 271, a housing 280, and a light source 290. The first rotatable element 220 includes reception holes 221 and 222. The second rotatable element 240 (for example, a cradle head of a tripod or a ball-and-socket joint) includes a ball 241, a stud 242, and a socket 243. The third rotatable element 260 (for example, a cradle head of a tripod or a ball-and-socket joint) includes a ball 261, a stud 262, and a socket 263. The housing 280 has an opening 281. The AC-DC converter 211 is disposed in the coupling portion 210. The first rotatable element 220 is connected to the coupling portion 210. The supporting arm 230 has two ends respectively connected to the reception hole 221 and the second rotatable element 240. The second rotatable element 240 is connected to the main body 250. The reflector 271 is disposed on the reflector mount 270. The reflector mount 270 is connected to the third rotatable element 260. The third rotatable element 260 is connected to the main body 250. The housing 280 houses the main body 250. The light source 290 is disposed in the housing 280.

To use the hanger support 300, the coupling portion 210 is connected to a track (not shown) which is, for example, the track of a track light fixed to or suspended from a ceiling in advance. The hanger support 300 is movable along the track (not shown) to change the location thereof in three-dimensional space in accordance with the requirements. The track (not shown) is capable of providing AC power. Thus, the coupling portion 210 is capable of receiving AC power from the track (not shown) through a connection of the coupling portion 210 to the track (not shown). In operation, the coupling portion 210 receives AC power from the track (not shown) and the AC power is converted to DC power by the AC-DC converter 211 disposed in the coupling portion 210 for the light source 290 and other devices to use. The first rotatable element 220 is rotatable about an axis C to rotate the supporting arm 230, move the main body 250, and change the position of the main body 250 in three-dimensional space. The ball 241 can be rotated with respect to the socket 243 to rotate the stud 242. Therefore, the main body 250 connected to the stud 242 can be rotated in three-dimensional space by means of rotation of the ball 241. The ball 261 can be rotated with respect to the socket 263 to rotate the stud 262. Therefore, the reflector mount 270 connected to the stud 262 can be rotated in three-dimensional space, by means of rotation of the ball 261, to rotate the reflector 271. The light source 290 is configured to provide illumination.

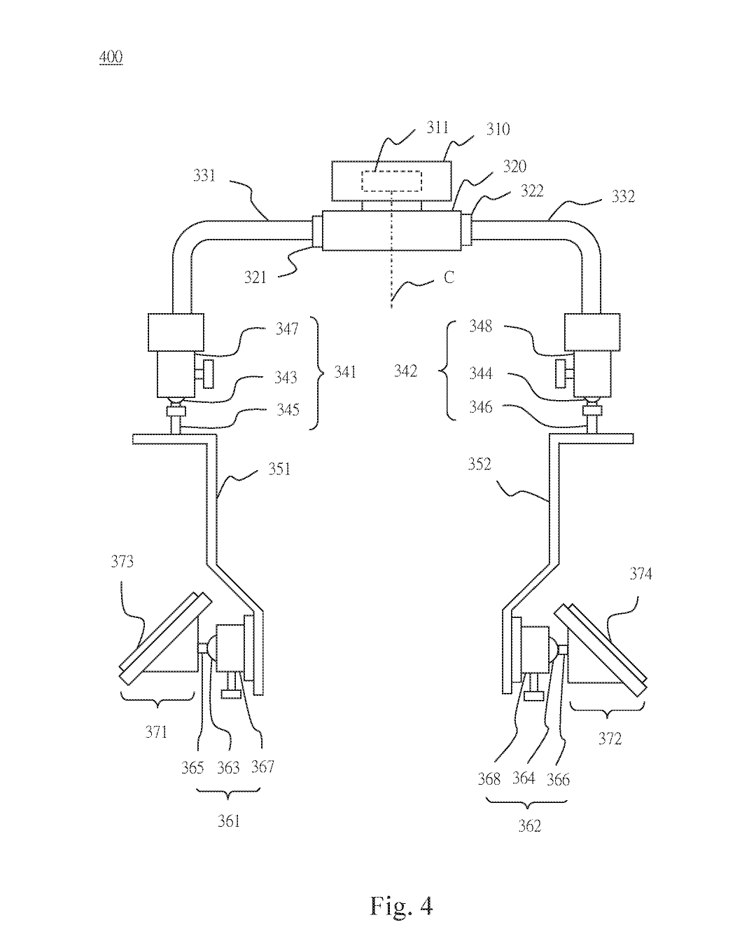

FIG. 4 depicts a hanger support in accordance with a fourth embodiment of the invention, wherein the hanger support 400 includes a coupling portion 310, an AC-DC converter 311, a first rotatable element 320, a supporting arm 331, a second rotatable element 341, a main body 351, a third rotatable element 361, a reflector mount 371, a reflector 373, a supporting arm 332, a fourth rotatable element 342, a main body 352, a fifth rotatable element 362, a reflector mount 372, and a reflector 374. The first rotatable element 320 includes reception holes 321 and 322. The second rotatable element 341 (for example, a cradle head of a tripod or a ball-and-socket joint) includes a ball 343, a stud 345, and a socket 347. The third rotatable element 361 (for example, a cradle head of a tripod or a ball-and-socket joint) includes a ball 363, a stud 365, and a socket 367. The fourth rotatable element 342 (for example, a cradle head of a tripod or a ball-and-socket joint) includes a ball 344, a stud 346, and a socket 348. The fifth rotatable element 362 (for example, a cradle head of a tripod or a ball-and-socket joint) includes a ball 364, a stud 366, and a socket 368. The AC-DC converter 311 is disposed in the coupling portion 310. The first rotatable element 320 is connected to the coupling portion 310. The supporting arm 331 has two ends respectively connected to the reception hole 321 and the second rotatable element 341. The second rotatable element 341 is connected to the main body 351. The reflector 373 is disposed on the reflector mount 371. The reflector mount 371 is connected to the third rotatable element 361. The third rotatable element 361 is connected to the main body 351. The supporting arm 332 has two ends respectively connected to the reception hole 322 and the fourth rotatable element 342. The fourth rotatable element 342 is connected to the main body 352. The reflector 374 is disposed on the reflector mount 372. The reflector mount 372 is connected to the fifth rotatable element 362. The fifth rotatable element 362 is connected to the main body 352.

To use the hanger support 400, the coupling portion 310 is connected to a track (not shown) which is, for example, the track of a track light fixed to or suspended from a ceiling in advance. The hanger support 400 is movable along the track (not shown) to change the location thereof in three-dimensional space in accordance with the requirements. The track (not shown) is capable of providing AC power. Thus, the coupling portion 310 is capable of receiving AC power from the track (not shown) through a connection of the coupling portion 310 to the track (not shown). In operation, the coupling portion 310 receives AC power from the track (not shown) and the AC power is converted to DC power by the AC-DC converter 311 disposed in the coupling portion 310 for other devices to use. The first rotatable element 320 is rotatable about an axis C to rotate the supporting arms 331 and 332, move the main bodies 351 and 352, and change the positions of the main bodies 351 and 352 in three-dimensional space. The balls 343 and 344 can be respectively rotated with respect to the sockets 347 and 348 to rotate the studs 345 and 346. Therefore, the main bodies 351 and 352 respectively connected to the studs 345 and 346 can be rotated in three-dimensional space by means of rotation of the balls 343 and 344. The balls 363 and 364 can be respectively rotated with respect to the sockets 367 and 368 to rotate the studs 365 and 366. Therefore, the reflector mounts 371 and 372 connected to the studs 365 and 366 can be rotated in three-dimensional space, by means of rotation of the balls 363 and 364, to rotate the reflectors 373 and 374.

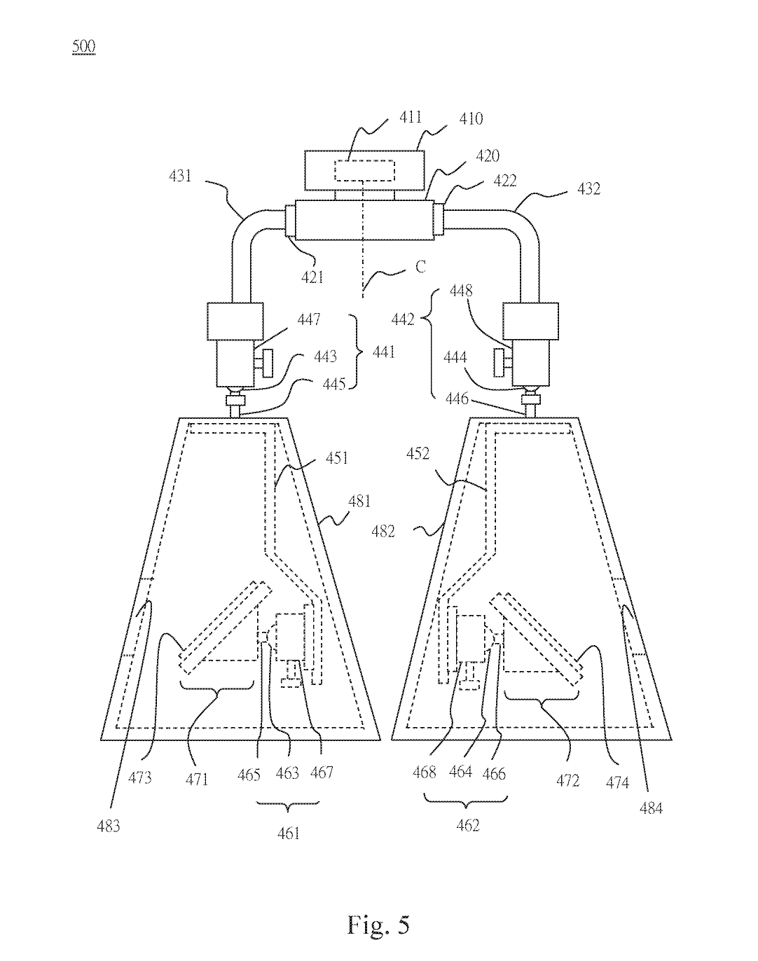

FIG. 5 depicts a hanger support in accordance with a fifth embodiment of the invention, wherein the hanger support 500 includes a coupling portion 410, an AC-DC converter 411, a first rotatable element 420, a supporting arm 431, a second rotatable element 441, a main body 451, a third rotatable element 461, a reflector mount 471, a reflector 473, a housing 481, a supporting arm 432, a fourth rotatable element 442, a main body 452, a fifth rotatable element 462, a reflector mount 472, a reflector 474, and a housing 482. The first rotatable element 420 includes reception holes 421 and 422. The second rotatable element 441 (for example, a cradle head of a tripod or a ball-and-socket joint) includes a ball 443, a stud 445, and a socket 447. The third rotatable element 461 (for example, a cradle head of a tripod or a ball-and-socket joint) includes a ball 463, a stud 465, and a socket 467. The fourth rotatable element 442 (for example, a cradle head of a tripod or a ball-and-socket joint) includes a ball 444, a stud 446, and a socket 448. The fifth rotatable element 462 (for example, a cradle head of a tripod or a ball-and-socket joint) includes a ball 464, a stud 466, and a socket 468. The housing 481 has an opening 483. The housing 482 has an opening 484. The AC-DC converter 411 is disposed in the coupling portion 410. The first rotatable element 420 is connected to the coupling portion 410. The supporting arm 431 has two ends respectively connected to the reception hole 421 and the second rotatable element 441. The second rotatable element 441 is connected to the main body 451. The reflector 473 is disposed on the reflector mount 471. The reflector mount 471 is connected to the third rotatable element 461. The third rotatable element 461 is connected to the main body 451. The supporting arm 432 has two ends respectively connected to the reception hole 422 and the fourth rotatable element 442. The fourth rotatable element 442 is connected to the main body 452. The reflector 474 is disposed on the reflector mount 472. The reflector mount 472 is connected to the fifth rotatable element 462. The fifth rotatable element 462 is connected to the main body 452. The housing 481 houses the main body 451. The housing 482 houses the main body 452.

To use the hanger support 500, the coupling portion 410 is connected to a track (not shown) which is, for example, the track of a track light fixed to or suspended from a ceiling in advance. The hanger support 500 is movable along the track (not shown) to change the location thereof in three-dimensional space in accordance with the requirements. The track (not shown) is capable of providing AC power. Thus, the coupling portion 410 is capable of receiving AC power from the track (not shown) through a connection of the coupling portion 410 to the track (not shown). In operation, the coupling portion 410 receives AC power from the track (not shown) and the AC power is converted to DC power by the AC-DC converter 411 disposed in the coupling portion 410 for other devices to use. The first rotatable element 420 is rotatable about an axis C to rotate the supporting arms 431 and 432, move the main bodies 451 and 452, and change the positions of the main bodies 451 and 452 in three-dimensional space. The balls 443 and 444 can be respectively rotated with respect to the sockets 447 and 448 to rotate the studs 445 and 446. Therefore, the main bodies 451 and 452 respectively connected to the studs 445 and 446 can be rotated in three-dimensional space by means of rotation of the balls 443 and 444. The balls 463 and 464 can be respectively rotated with respect to the sockets 467 and 468 to rotate the studs 465 and 466. Therefore, the reflector mounts 471 and 472 connected to the studs 465 and 466 can be rotated in three-dimensional space, by means of rotation of the balls 463 and 464, to rotate the reflectors 473 and 474.

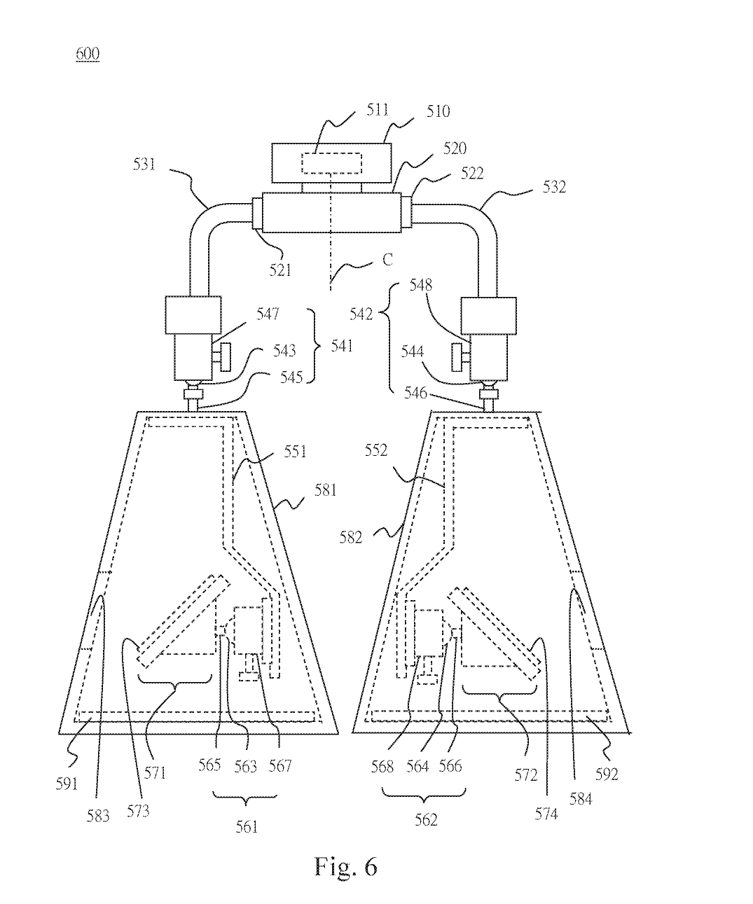

FIG. 6 depicts a hanger support in accordance with a sixth embodiment of the invention, wherein the hanger support 600 includes a coupling portion 510, an AC-DC converter 511, a first rotatable element 520, a supporting arm 531, a second rotatable element 541, a main body 551, a third rotatable element 561, a reflector mount 571, a reflector 573, a housing 581, a light source 591, a supporting arm 532, a fourth rotatable element 542, a main body 552, a fifth rotatable element 562, a reflector mount 572, a reflector 574, a housing 582, and a light source 592. The first rotatable element 520 includes reception holes 521 and 522. The second rotatable element 541 (for example, a cradle head of a tripod or a ball-and-socket joint) includes a ball 543, a stud 545, and a socket 547. The third rotatable element 561 (for example, a cradle head of a tripod or a ball-and-socket joint) includes a ball 563, a stud 565, and a socket 567. The fourth rotatable element 542 (for example, a cradle head of a tripod or a ball-and-socket joint) includes a ball 544, a stud 546, and a socket 548. The fifth rotatable element 562 (for example, a cradle head of a tripod or a ball-and-socket joint) includes a ball 564, a stud 566, and a socket 568. The housing 581 has an opening 583. The housing 582 has an opening 584. The light source 591 is disposed in the housing 581. The light source 592 is disposed in the housing 582. The AC-DC converter 511 is disposed in the coupling portion 510. The first rotatable element 520 is connected to the coupling portion 510. The supporting arm 531 has two ends respectively connected to the reception hole 521 and the second rotatable element 541. The second rotatable element 541 is connected to the main body 551. The reflector 573 is disposed on the reflector mount 571. The reflector mount 571 is connected to the third rotatable element 561. The third rotatable element 561 is connected to the main body 551. The supporting arm 532 has two ends respectively connected to the reception hole 522 and the fourth rotatable element 542. The fourth rotatable element 542 is connected to the main body 552. The reflector 574 is disposed on the reflector mount 572. The reflector mount 572 is connected to the fifth rotatable element 562. The fifth rotatable element 562 is connected to the main body 552. The housing 581 houses the main body 551. The housing 582 houses the main body 552. The light source 591 is disposed in the housing 581. The light source 592 is disposed in the housing 582.

To use the hanger support 600, the coupling portion 510 is connected to a track (not shown) which is, for example, the track of a track light fixed to or suspended from a ceiling in advance. The hanger support 600 is movable along the track (not shown) to change the location thereof in three-dimensional space in accordance with the requirements. The track (not shown) is capable of providing AC power. Thus, the coupling portion 510 is capable of receiving AC power from the track (not shown) through a connection of the coupling portion 510 to the track (not shown). In operation, the coupling portion 510 receives AC power from the track (not shown) and the AC power is converted to DC power by the AC-DC converter 511 disposed in the coupling portion 510 for the light sources 591, 592 and other devices to use. The first rotatable element 520 is rotatable about an axis C to rotate the supporting arms 531 and 532, move the main bodies 551 and 552, and change the positions of the main bodies 551 and 552 in three-dimensional space. The balls 543 and 544 can be respectively rotated with respect to the sockets 547 and 548 to rotate the studs 545 and 546. Therefore, the main bodies 551 and 552 respectively connected to the studs 545 and 546 can be rotated in three-dimensional space by means of rotation of the balls 543 and 544. The balls 563 and 564 can be respectively rotated with respect to the sockets 567 and 568 to rotate the studs 565 and 566. Therefore, the reflector mounts 571 and 572 connected to the studs 565 and 566 can be rotated in three-dimensional space, by means of rotation of the balls 563 and 564, to rotate the reflectors 573 and 574. The light sources 591 and 592 are configured to provide illumination.

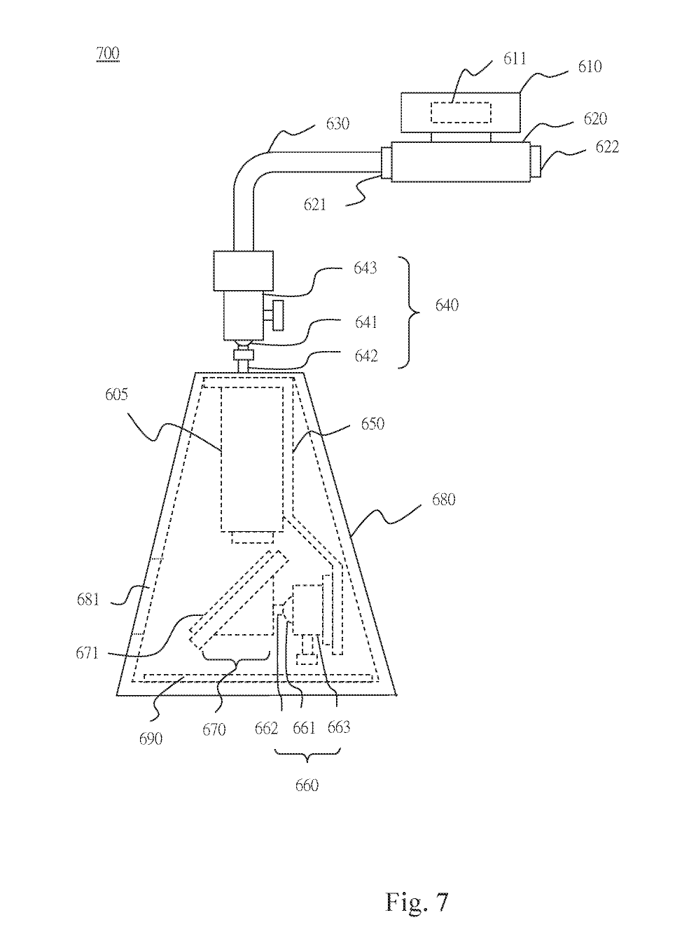

FIG. 7 depicts a projection device in accordance with a first embodiment of the invention, wherein the projection device 700 includes a projector 605 and a hanger support. The hanger support includes a coupling portion 610, an AC-DC converter 611, a first rotatable element 620, a supporting arm 630, a second rotatable element 640, a main body 650, a third rotatable element 660, a reflector mount 670, a reflector 671, a housing 680, and a light source 690. The first rotatable element 620 includes reception holes 621 and 622. The second rotatable element 640 (for example, a cradle head of a tripod or a ball-and-socket joint) includes a ball 641, a stud 642, and a socket 643. The third rotatable element 660 (for example, a cradle head of a tripod or a ball-and-socket joint) includes a ball 661, a stud 662, and a socket 663. The housing 680 has an opening 681. The AC-DC converter 611 is disposed in the coupling portion 610. The first rotatable element 620 is connected to the coupling portion 610. The supporting arm 630 has two ends respectively connected to the reception hole 621 and the second rotatable element 640. The second rotatable element 640 is connected to the main body 650. The reflector 671 is disposed on the reflector mount 670. The reflector mount 670 is connected to the third rotatable element 660. The third rotatable element 660 is connected to the main body 650. The housing 680 houses the main body 650. The light source 690 is disposed in the housing 680. The projector 605 is fixed to the hanger support via a connection to the main body 650.

To install the projection device 700 for use, the coupling portion 610 is connected to a track (not shown) which is, for example, the track of a track light fixed to or suspended from a ceiling in advance. The track (not shown) is capable of providing AC power. Thus, the coupling portion 610 is capable of receiving AC power from the track (not shown) through a connection of the coupling portion 610 to the track (not shown). In operation, the coupling portion 610 receives AC power from the track (not shown) and the AC power is converted to DC power by the AC-DC converter 611 disposed in the coupling portion 610 for the projector 605 and the light source 690 to use. The projector 605 is capable of projecting audio/video/image contents (not shown) to the reflector 671. The audio/video/image contents are reflected from the reflector 671 through the opening 681 of the housing 680 to a projection screen or a wall or any object surfaces. The location where the audio/video/image contents are projected is adjustable in accordance with user's requirements, by moving the hanger support along the track (not shown), rotating the first rotatable element 620, or rotating the ball 641 or 661. The light source 690 provides illumination after turned on.

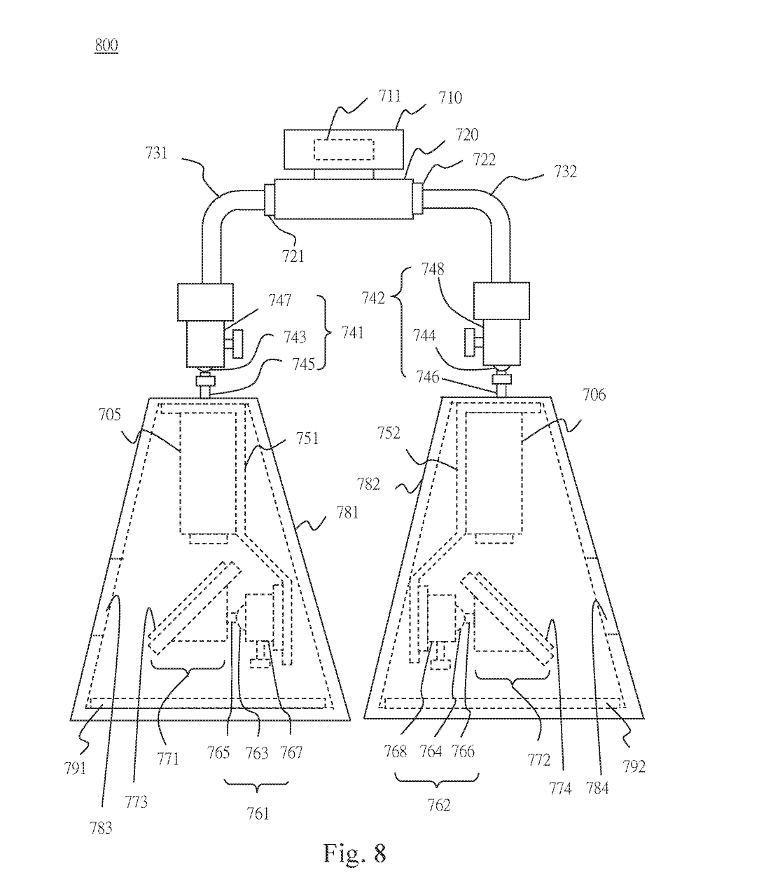

FIG. 8 depicts a projection device in accordance with a second embodiment of the invention, wherein the projection device 800 includes a projector 705, a projector 706, and a hanger support. The hanger support includes a coupling portion 710, an AC-DC converter 711, a first rotatable element 720, a supporting arm 731, a second rotatable element 741, a main body 751, a third rotatable element 761, a reflector mount 771, a reflector 773, a housing 781, a light source 791, a supporting arm 732, a fourth rotatable element 742, a main body 752, a fifth rotatable element 762, a reflector mount 772, a reflector 774, a housing 782, and a light source 792. The first rotatable element 720 includes reception holes 721 and 722. The second rotatable element 741 (for example, a cradle head of a tripod or a ball-and-socket joint) includes a ball 743, a stud 745, and a socket 747. The third rotatable element 761 (for example, a cradle head of a tripod or a ball-and-socket joint) includes a ball 763, a stud 765, and a socket 767. The fourth rotatable element 742 (for example, a cradle head of a tripod or a ball-and-socket joint) includes a ball 744, a stud 746, and a socket 748. The fifth rotatable element 762 (for example, a cradle head of a tripod or a ball-and-socket joint) includes a ball 764, a stud 766, and a socket 768. The housing 781 has an opening 783. The housing 782 has an opening 784. The light source 791 is disposed in the housing 781. The light source 792 is disposed in the housing 782. The AC-DC converter 711 is disposed in the coupling portion 710. The first rotatable element 720 is connected to the coupling portion 710. The supporting arm 731 has two ends respectively connected to the reception hole 721 and the second rotatable element 741. The second rotatable element 741 is connected to the main body 751. The reflector 773 is disposed on the reflector mount 771. The reflector mount 771 is connected to the third rotatable element 761. The third rotatable element 761 is connected to the main body 751. The supporting arm 732 has two ends respectively connected to the reception hole 722 and the fourth rotatable element 742. The fourth rotatable element 742 is connected to the main body 752. The reflector 774 is disposed on the reflector mount 772. The reflector mount 772 is connected to the fifth rotatable element 762. The fifth rotatable element 762 is connected to the main body 752. The housing 781 houses the main body 751. The housing 782 houses the main body 752. The light source 791 is disposed in the housing 781. The light source 792 is disposed in the housing 782. The projectors 705 and 706 are respectively fixed to the hanger supports via a connection to the main bodies 751 and 752.

To install the projection device 800 for use, the coupling portion 710 is connected to a track (not shown) which is, for example, the track of a track light fixed to or suspended from a ceiling in advance. The track (not shown) is capable of providing AC power. Thus, the coupling portion 710 is capable of receiving AC power from the track (not shown) through a connection of the coupling portion 710 to the track (not shown). In operation, the coupling portion 710 receives AC power from the track (not shown) and the AC power is converted to DC power by the AC-DC converter 711 disposed in the coupling portion 710 for the projectors 705, 706 and the light sources 791, 792 to use. The projectors 705 and 706 are capable of respectively projecting audio/video/image contents (not shown) to the reflectors 773 and 774. The audio/video/image contents are reflected from the reflectors 773 and 774 respectively through the openings 783 and 784 of the housings 781 and 782 to a projection screen or a wall or any object surfaces. The locations where the audio/video/image contents are projected are adjustable in accordance with user's requirements. In this embodiment, the audio/video/image contents (not shown) can be projected onto different walls, projected on the same wall with one superposed or overlapped on the other, or projected onto the same wall with the edges thereof connected. When the audio/video/image contents are projected onto the same wall with the edges thereof connected, an enlarged picture is obtained without the requirement of increasing a distance between the projection device and the wall. The locations where the audio/video/image contents are projected can be adjusted by moving the hanger support along the track (not shown), rotating the first rotatable element 720, or rotating the ball 743, 744, 763, or 764. The light sources 791 and 792 provide illumination after turned on.

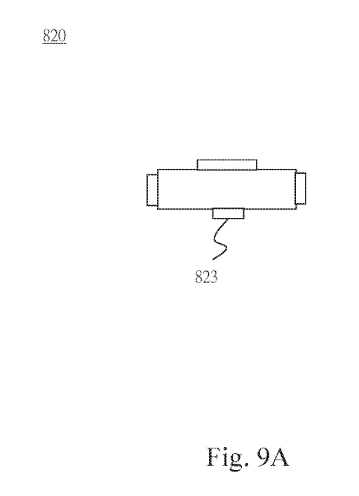

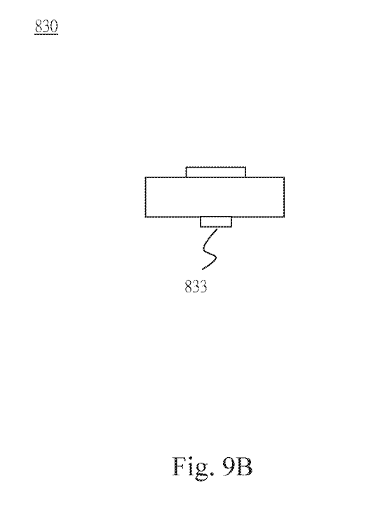

It is understood that the first rotatable elements and the L-shaped supporting arms in the first, second, and third embodiments of the hanger supports can be respectively modified as a first rotatable element 820 of FIG. 9A and a linear supporting arm, and the linear supporting arm is connected to a reception hole 823 of the first rotatable element 820 of FIG. 9A in an installation of the hanger support. Alternatively, the first rotatable elements and the L-shaped supporting arms of the hanger supports in the first, second, and third embodiments can be respectively modified as a first rotatable element 830 of FIG. 9B and a linear supporting arm, and the linear supporting arm is connected to a reception hole 833 of the first rotatable element 830 of FIG. 9B in an installation of the hanger support. Both of the modifications belong to the category of the invention.

As described, the supporting arm 630 is connected to the reception hole 621 of the first rotatable element 620 in the first embodiment of the projection device 700. It is understood that the first rotatable element 620 and the L-shaped supporting arm 630 in the first embodiment of the projection device 700 can be respectively modified as the first rotatable element 820 of FIG. 9A and a linear supporting arm, and the linear supporting arm is connected to the reception hole 823 of the first rotatable element 820 of FIG. 9A in an installation of the projection device. Alternatively, the first rotatable element 620 and the L-shaped supporting arm 630 of the first embodiment of the projection device 700 can be respectively modified as the first rotatable element 830 of FIG. 9B and a linear supporting arm, and the linear supporting arm is connected to the reception hole 833 of the first rotatable element 830 of FIG. 9B in an installation of the projection device. Both of the modifications belong to the category of the invention.

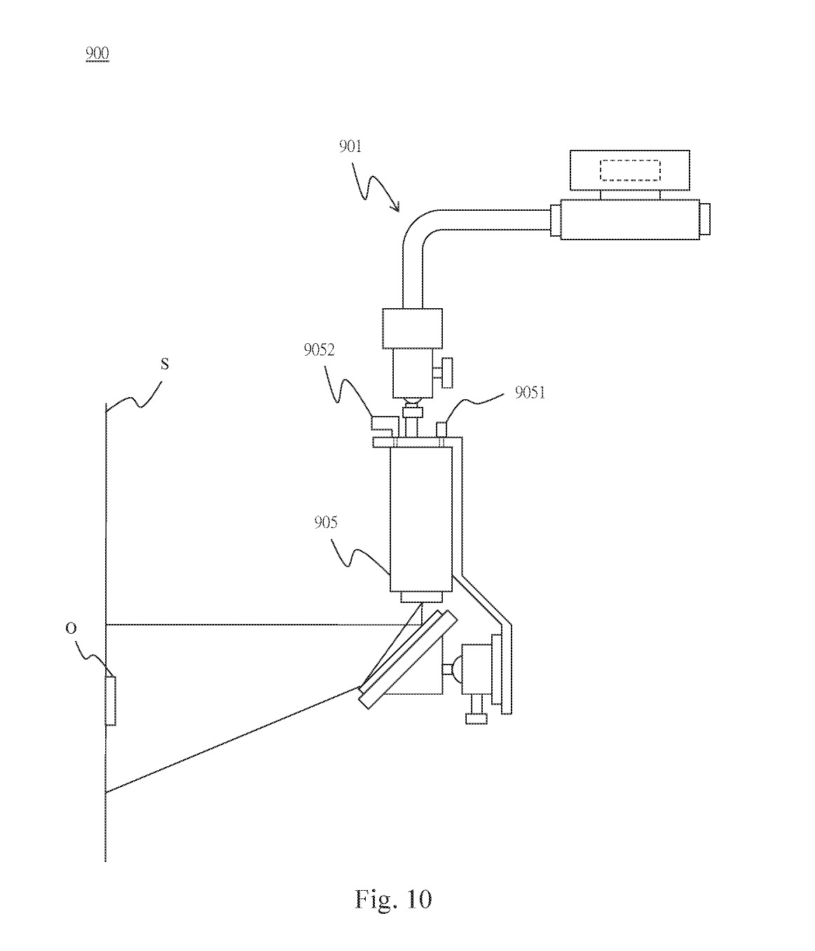

FIG. 10 depicts a projection device in accordance with a third embodiment of the invention, wherein the projection device 900 includes a hanger support 901, a projector 905, a receiver 9051, and a multimedia capturing device 9052. The structure of the hanger support 901 is similar to that of FIG. 1 and the descriptions thereof are omitted. The projector 905 is fixed to the hanger support 901 via a connection to the main body of the hanger support 901. The receiver 9051 and the multimedia capturing device 9052 are connected to the projector 905. The receiver 9051 is configured to receive a multimedia signal for the projector 905 to project audio/video/image contents of the multimedia signal. The multimedia capturing device 9052 is configured to record the surrounding videos, images and sounds and transmit the recorded videos, images and sounds to a far-end device (e.g. a control computer, not shown) via a cable network or a wireless network. The far-end device analyzes the received videos, images and sounds and generates proper videos, images and sounds. The receiver 9051 receives the proper images and sounds from the far-end device, for the projector 905 to project audio/video/image contents of the proper videos, images and sounds onto a projection screen S.

The projection device 900 can be used for producing a projection-mapping film and making a projection-mapping display. As shown in FIG. 10, an object O is attached to the projection screen S in advance. In operation, a device (e.g. control computer, not shown) transmits a multimedia signal to the receiver 9051 via a cable network or a wireless network. The audio/video/image contents of the multimedia signal are projected onto the projection screen S by the projector 905. The multimedia capturing device 9052 captures audio/video/image contents from the projection screen S and transmits the captured audio/video/image contents to the device via a cable network or a wireless network. The device determines if the audio/video/image contents of the multimedia signal are correctly projected onto the projection screen S in accordance with the audio/video/image contents captured by the multimedia capturing device 9052. If the location where the audio/video/image contents of the multimedia signal are projected onto the projection screen S is incorrect, then the device reedits the audio/video/image contents of the multimedia signal and transmits the reedited audio/video/image contents to the receiver 9051 via the cable network or the wireless network. Then, the reedited audio/video/image contents of the multimedia signal are projected onto the projection screen S by the projector 905. The multimedia capturing device 9052 captures audio/video/image contents from the projection screen S and transmits the captured audio/video/image contents to the device via a cable network or a wireless network. Again, the device determines if the audio/video/image contents of the multimedia signal are correctly projected onto the projection screen S in accordance with the audio/video/image contents captured by the multimedia capturing device 9052. The above operations are repeated until the audio/video/image contents of the multimedia signal are correctly projected onto the projection screen S, thereby producing a projection-mapping film. Afterwards, the produced projection-mapping film can be projected onto the projection screen S by the projection device 900 to make a projection-mapping display which provides abundant, three-dimensional visual enjoyments for the viewers.

The projection device 900 can be further used for providing interactive advertising. As shown in FIG. 10, when a pedestrian (not shown) approaches the projection screen S, the multimedia capturing device 9052 captures an image and a sound from the pedestrian and transmits the image and sound to a device (e.g. control computer, not shown) via a cable network or a wireless network. The device identifies the pedestrian's characteristics including sex, age, face, dressing, carry-on articles, body movements, and conversation in accordance with the captured image and sound, and generates a special multimedia signal corresponding to the identification. The special multimedia signal is transmitted to the receiver 9051 through the cable network or wireless network. The audio/video/image contents of the special multimedia signal are projected onto the projection screen S by the projector 905 to draw the pedestrian's attentions, thereby increasing the possibility for the pedestrian to stop to watch advertisements and improving the effects of the advertisements. The multimedia capturing device 9052 continues to transmit the pedestrian's images and sounds to the device so that the device can update the special multimedia signal. Thus, the pedestrian is able to interact with the device by watching the audio/video/image contents of the special multimedia signal. As compared with normal advertising, such an interactive advertising provides the viewers with different experiences.

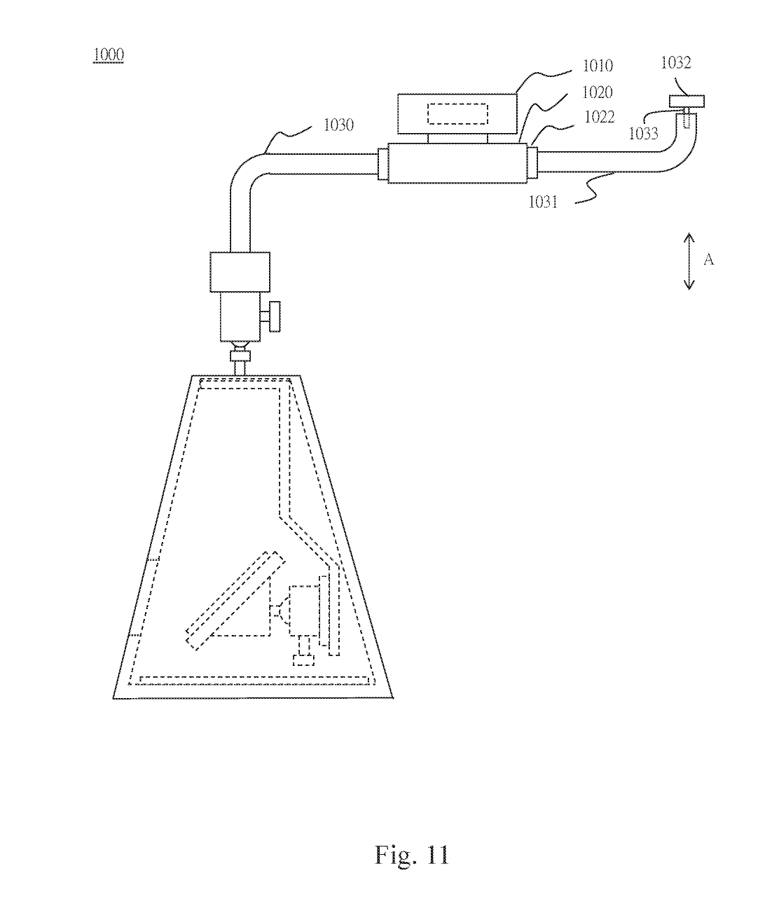

FIG. 11 depicts a hanger support in accordance with a seventh embodiment of the invention, wherein the hanger support 1000 of the seventh embodiment includes a balance arm 1031 and a top mount 1032 which are not included by the hanger support 300 of the third embodiment. The top mount 1032 includes a screw 1033 on the bottom thereof. The balance arm 1031 has two ends respectively connected to the reception hole 1022 and the screw 1033 of the top mount 1032. The top mount 1032 is configured to push against a ceiling (not shown). The top mount 1032 is rotatable to rotate the screw 1033 so that the top mount 1032 can move along the opposite arrows A. Therefore, the length of the top mount 1032 protruding from the balance arm 1031 is adjustable. Other elements of the hanger support 1000 are similar with those of the hanger support 300 and the descriptions thereof are omitted. The structure of hanger support 1000 is asymmetric, wherein the elements on the left side of the first rotatable element 1020 are more than the elements on the right side of the first rotatable element 1020. When the coupling portion 1010 of the hanger support 1000 is connected to a track (e.g. the track of a track light fixed to or suspended from a ceiling in advance, not shown), the hanger support 1000 tends to tilt with the supporting arm 1030 lowered and the balance arm 1031 raised because of the asymmetric structure (the elements on the left side exceed the elements on the right side in total weight). To solve this problem, the top mount 1032 pushing against the ceiling can be rotated to protrude more from the balance arm 1031 until the supporting arm 1030 and the balance arm 1031 are at the same height as shown in FIG. 11 (i.e. the supporting arm 1030 is not lowered and the balance arm 1031 is not raised either).

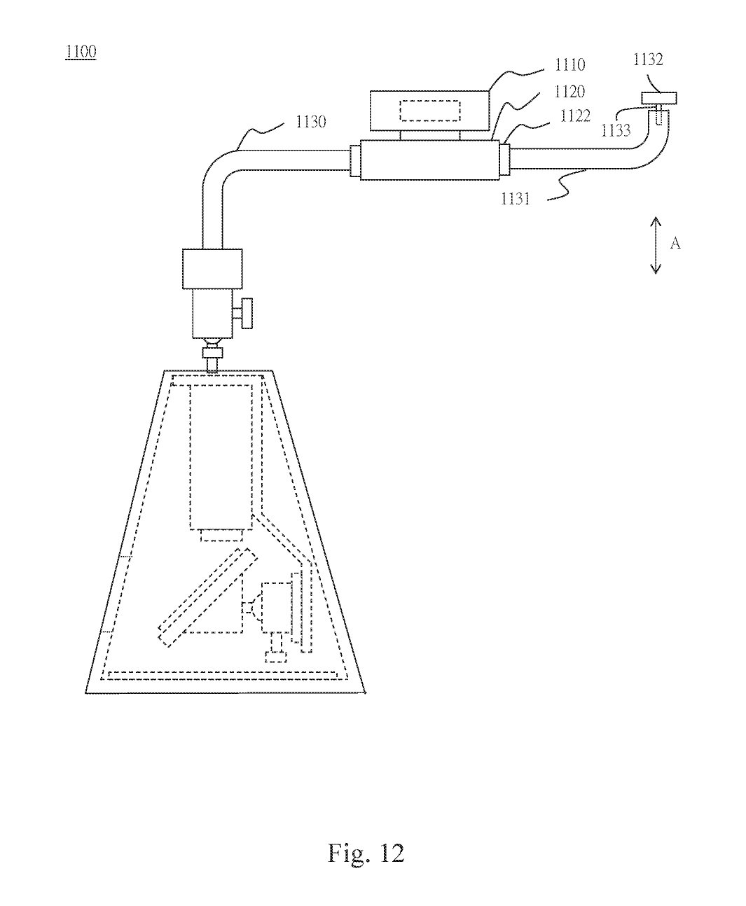

FIG. 12 depicts a projection device in accordance with a fourth embodiment of the invention, wherein the projection device 1100 of the fourth embodiment includes a balance arm 1131 and a top mount 1132 which are not included by the projection device 700 of the first embodiment. The top mount 1132 includes a screw 1133 on the bottom thereof. The balance arm 1131 has two ends respectively connected to the reception hole 1122 and the screw 1133 of the top mount 1132. The top mount 1132 is configured to push against a ceiling (not shown). The top mount 1132 is rotatable to rotate the screw 1133 so that the top mount 1132 can move along the opposite arrows A. Therefore, the length of the top mount 1132 protruding from the balance arm 1131 is adjustable. Other elements of the projection device 1100 are similar with those of the projection device 700 and the descriptions thereof are omitted. The structure of projection device 1100 is asymmetric, wherein the elements on the left side of the first rotatable element 1120 are more than the elements on the right side of the first rotatable element 1120. When the coupling portion 1110 of the projection device 1100 is connected to a track (e.g. the track of a track light fixed to or suspended from a ceiling in advance, not shown), the projection device 1100 tends to tilt with the supporting arm 1130 lowered and the balance arm 1131 raised because of the asymmetric structure (the elements on the left side exceed the elements on the right side in total weight). To solve this problem, the top mount 1132 pushing against the ceiling can be rotated to protrude more from the balance arm 1131 until the supporting arm 1130 and the balance arm 1131 are at the same height as shown in FIG. 12 (i.e. the supporting arm 1130 is not lowered and the balance arm 1131 is not raised either).

It is understood that the projection device 1100 of the fourth embodiment can be modified to include a receiver and a multimedia capturing device both of which are connected to the projector. Such a modification belongs to the category of the invention.

The projection device of the invention has a coupling portion for connecting to a track, which facilitates an installation of the projection device, while an installation of a projection device through a conventional hanger support is complicated. Also, the invention is able to facilitate the cable arrangement and space design in the ceiling. In the invention, the track of a track light mounted on the ceiling in advance is utilized to install a projection device. Therefore, the installation of a projection device is simplified. Wall pictures and poster billboards can be replaced with the projection device of the invention to project images for exhibition. Changing the projected images is easier than changing the wall pictures and poster billboards. When images are projected by the projection device of the invention, the light source connected to the housing generates light to provide illumination.

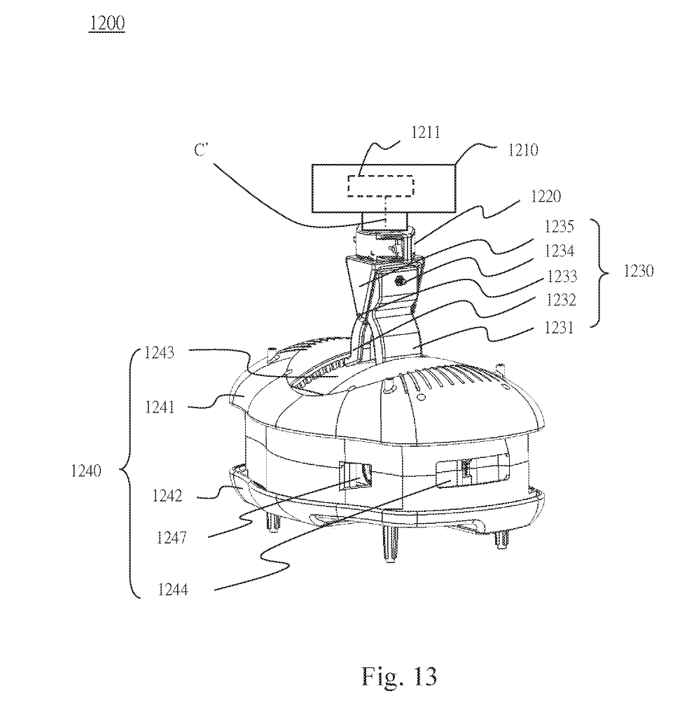

FIG. 13 depicts a hanger support in accordance with an eighth embodiment of the invention, wherein the hanger support 1200 includes a coupling portion 1210, an AC-DC converter 1211, a first rotatable element 1220, an engaging assembly 1230, and a main body 1240. The engaging assembly 1230 includes a right engaging element 1231, a left engaging element 1232, a fixing screw 1233, an adjusting screw 1234, and a bracket 1235. The main body 1240 includes an upper cover 1241 and a lower cover 1242. An upper groove 1243 is formed on the upper cover 1241. A right groove 1244, a left groove (not shown), a rear groove (not shown), and an opening 1247 are formed on the edges of the upper cover 1241 and the lower cover 1242 which are joined. The AC-DC converter 1211 is disposed in the coupling portion 1210. The first rotatable element 1220 is connected to the coupling portion 1210. The bracket 1235 is connected to the first rotatable element 1220. The right engaging element 1231 and a left engaging element 1232 are connected to the bracket 1235 through the fixing screw 1233. The adjusting screw 1234 connects the right engaging element 1231 and the left engaging element 1232. The opening 1247 is configured to allow light in the main body to pass through.

To use the hanger support 1200, the coupling portion 1210 is connected to a track (not shown) which is, for example, the track of a track light fixed to or suspended from a ceiling in advance. The hanger support 1200 is movable along the track (not shown) to change the location thereof in three-dimensional space in accordance with the requirements. The track (not shown) is capable of providing AC power. Thus, the coupling portion 1210 is capable of receiving AC power from the track (not shown) through a connection of the coupling portion 1210 to the track (not shown). In operation, the coupling portion 1210 receives AC power from the track (not shown) and the AC power is converted to DC power by the AC-DC converter 1211 disposed in the coupling portion 1210 for other devices to use. The first rotatable element 1220 is rotatable about an axis C′ to rotate the main body 1240. The adjusting screw 1234 is rotatable to adjust the distance between the bottoms of the right engaging element 1231 and the left engaging element 1232, so that the right engaging element 1231 and the left engaging element 1232 can be engaged with or separated from the upper groove 1243. Also, the right engaging element 1231 and the left engaging element 1232 can be slid along the upper groove 1243. Because the upper groove 1243 is curved on the bottom thereof, the angle of inclination of the main body 1240 can be adjusted when the right engaging element 1231 and the left engaging element 1232 are slid along the upper groove 1243. The opening 1247 is configured to allow light in the main body 1240 to pass through. When a projector (not shown) is disposed in the main body 1240, light projected by the projector is able to exit from the main body 1240 through the opening 1247, and the projection angle of the projector is adjustable by sliding the right engaging element 1231 and the left engaging element 1232 along the upper groove 1243.

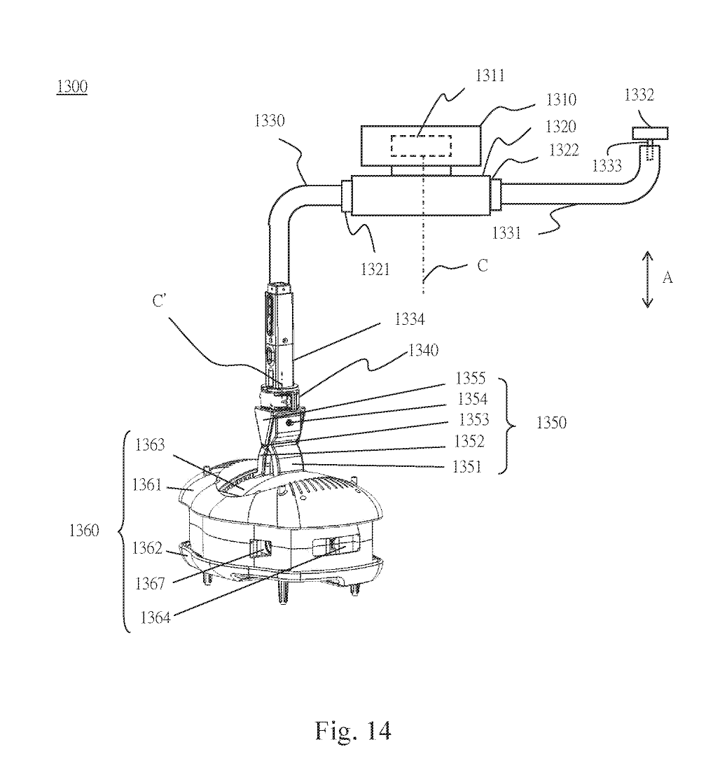

FIG. 14 depicts a hanger support in accordance with a ninth embodiment of the invention, wherein the hanger support 1300 includes a coupling portion 1310, an AC-DC converter 1311, a first rotatable element 1320, a supporting arm 1330, a balance arm 1331, a top mount 1332, a fixing mount 1334, a second rotatable element 1340, an engaging assembly 1350, and a main body 1360. The first rotatable element 1320 includes a reception hole 1321 and a reception hole 1322. The top mount 1332 includes a screw 1333. The engaging assembly 1350 includes a right engaging element 1351, a left engaging element 1352, a fixing screw 1353, an adjusting screw 1354, and a bracket 1355. The main body 1360 includes an upper cover 1361 and a lower cover 1362. An upper groove 1363 is formed on the upper cover 1361. A right groove 1364, a left groove (not shown), a rear groove (not shown), and an opening 1367 are formed on the edges of the upper cover 1361 and the lower cover 1362 which are joined. The AC-DC converter 1311 is disposed in the coupling portion 1310. The first rotatable element 1320 is connected to the coupling portion 1310. The supporting arm 1330 has two ends connected to the reception hole 1321 and the fixing mount 1334. The fixing mount 1334 is connected to the second rotatable element 1340. The second rotatable element 1340 is connected to the bracket 1355. The right engaging element 1351 and a left engaging element 1352 are connected to the bracket 1355 through the fixing screw 1353. The adjusting screw 1354 connects the right engaging element 1351 and the left engaging element 1352. The balance arm 1331 has two ends connected to the reception hole 1322 and the screw 1333 of the top mount 1332. The top mount 1332 is configured to push against a ceiling (not shown).

To use the hanger support 1300, the coupling portion 1310 is connected to a track (not shown) which is, for example, the track of a track light fixed to or suspended from a ceiling in advance. The hanger support 1300 is movable along the track (not shown) to change the location thereof in three-dimensional space in accordance with the requirements. The track (not shown) is capable of providing AC power. Thus, the coupling portion 1310 is capable of receiving AC power from the track (not shown) through a connection of the coupling portion 1310 to the track (not shown). In operation, the coupling portion 1310 receives AC power from the track (not shown) and the AC power is converted to DC power by the AC-DC converter 1311 disposed in the coupling portion 1310 for other devices to use. The first rotatable element 1320 is rotatable about an axis C to rotate the supporting arm 1330 and the balance arm 1331, move the main body 1360, and change the position of the main body 1360 in three-dimensional space. The second rotatable element 1340 is rotatable about an axis C′ to rotate the main body 1360. The structure of hanger support 1300 is asymmetric, wherein the elements on the left side of the first rotatable element 1320 are more than the elements on the right side of the first rotatable element 1320. The hanger support 1300 tends to tilt with the supporting arm 1330 lowered and the balance arm 1331 raised because of the asymmetric structure (the elements on the left side exceed the elements on the right side in total weight). To solve this problem, the top mount 1332 pushing against the ceiling can be rotated to rotate the screw 1333 so that the top mount 1332 can move along the opposite arrows A. Therefore, the length of the top mount 1332 protruding from the balance arm 1331 is adjustable. By this arrangement, the top mount 1332 pushing against the ceiling can be rotated to protrude more from the balance arm 1331 until the supporting arm 1330 and the balance arm 1331 are at the same height as shown in FIG. 14 (i.e. the supporting arm 1330 is not lowered and the balance arm 1331 is not raised either). The adjusting screw 1354 is rotatable to adjust the distance between the bottoms of the right engaging element 1351 and the left engaging element 1352, so that the right engaging element 1351 and the left engaging element 1352 can be engaged with or separated from the upper groove 1363. Also, the right engaging element 1351 and the left engaging element 1352 can be slid along the upper groove 1363. Because the upper groove 1363 is curved on the bottom thereof, the angle of inclination of the main body 1360 can be adjusted when the right engaging element 1351 and the left engaging element 1352 are slid along the upper groove 1363. The opening 1367 is configured to allow light in the main body 1360 to pass through. When a projector (not shown) is disposed in the main body 1360, light projected by the projector is able to exit from the main body 1360 through the opening 1367, and the projection angle of the projector is adjustable by sliding the right engaging element 1351 and the left engaging element 1352 along the upper groove 1363.

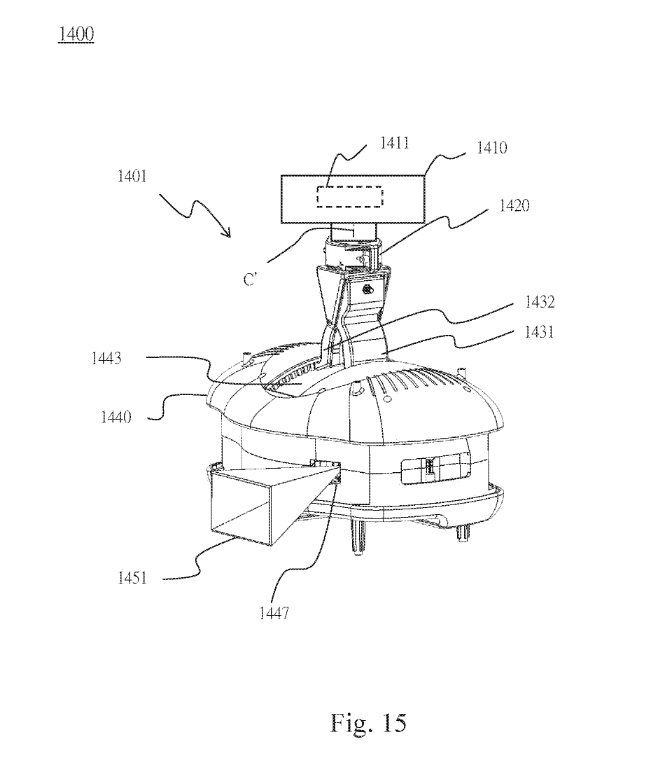

FIG. 15 depicts a projection device in accordance with a fifth embodiment of the invention, wherein the projection device 1400 includes a projector (not shown) and a hanger support 1401. The structure of the hanger support 1401 is similar with that of the hanger support 1200 of FIG. 13 and the descriptions thereof are omitted. The projector is disposed in the main body 1440 and fixed to the hanger support 1401.

To install the projection device 1400 for use, the coupling portion 1410 is connected to a track (not shown) which is, for example, the track of a track light fixed to or suspended from a ceiling in advance. The track (not shown) is capable of providing AC power. Thus, the coupling portion 1410 is capable of receiving AC power from the track (not shown) through a connection of the coupling portion 1410 to the track (not shown). In operation, the coupling portion 1410 receives AC power from the track (not shown) and the AC power is converted to DC power by the AC-DC converter 1411 disposed in the coupling portion 1410 for the projector (not shown) to use. The projector is able to project light 1451 which contains audio/video/image contents, through the opening 1447, to a projection screen or a wall or surfaces of other objects, wherein the projected audio/video/image contents are rectangular and have a horizontal side longer than a vertical side. The location where the light 1451 containing the audio/video/image contents are projected is adjustable, in accordance with user's requirements, by moving the hanger support 1401 along the track (not shown), rotating the first rotatable element 1420 about an axis C′, and sliding the right engaging element 1431 and the left engaging element 1432 along the upper groove 1443.

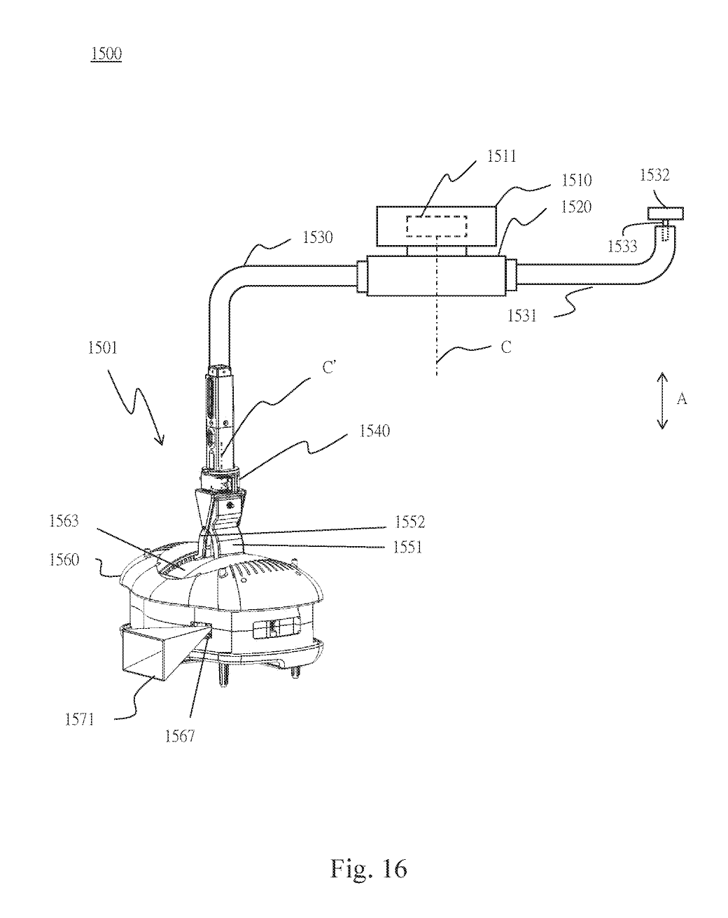

FIG. 16 depicts a projection device in accordance with a sixth embodiment of the invention, wherein the projection device 1500 includes a projector (not shown) and a hanger support 1501. The structure of the hanger support 1501 is similar with that of the hanger support 1300 of FIG. 14 and the descriptions thereof are omitted. The projector is disposed in the main body 1560 and fixed to the hanger support 1501.

To install the projection device 1500 for use, the coupling portion 1510 is connected to a track (not shown) which is, for example, the track of a track light fixed to or suspended from a ceiling in advance. The track (not shown) is capable of providing AC power. Thus, the coupling portion 1510 is capable of receiving AC power from the track (not shown) through a connection of the coupling portion 1510 to the track (not shown). In operation, the coupling portion 1510 receives AC power from the track (not shown) and the AC power is converted to DC power by the AC-DC converter 1511 disposed in the coupling portion 1510 for the projector (not shown) to use. The structure of the projection device 1500 is asymmetric. The hanger support 1501 tends to tilt with the supporting arm 1530 lowered and the balance arm 1531 raised because of the asymmetric structure (the elements on the left side exceed the elements on the right side in total weight). To solve this problem, the top mount 1532 can be rotated to rotate the screw 1533 so that the top mount 1532 can move along the opposite arrows A. Therefore, the length of the top mount 1532 protruding from the balance arm 1531 is adjustable. By this arrangement, the top mount 1532 pushing against the ceiling can be rotated to protrude more from the balance arm 1531 until the supporting arm 1530 and the balance arm 1531 are at the same height as shown in FIG. 16 (i.e. the supporting arm 1530 is not lowered and the balance arm 1531 is not raised either). The projector is able to project light 1571 which contains audio/video/image contents, through the opening 1567, to a projection screen or a wall or surfaces of other objects, wherein the projected audio/video/image contents are rectangular and have a horizontal side longer than a vertical side. The location where the light 1571 containing the audio/video/image contents is projected is adjustable, in accordance with user's requirements, by moving the hanger support 1501 along the track (not shown), rotating the first rotatable element 1520 about an axis C, rotating the second rotatable element 1540 about an axis C′, and sliding the right engaging element 1551 and the left engaging element 1552 along the upper groove 1563.

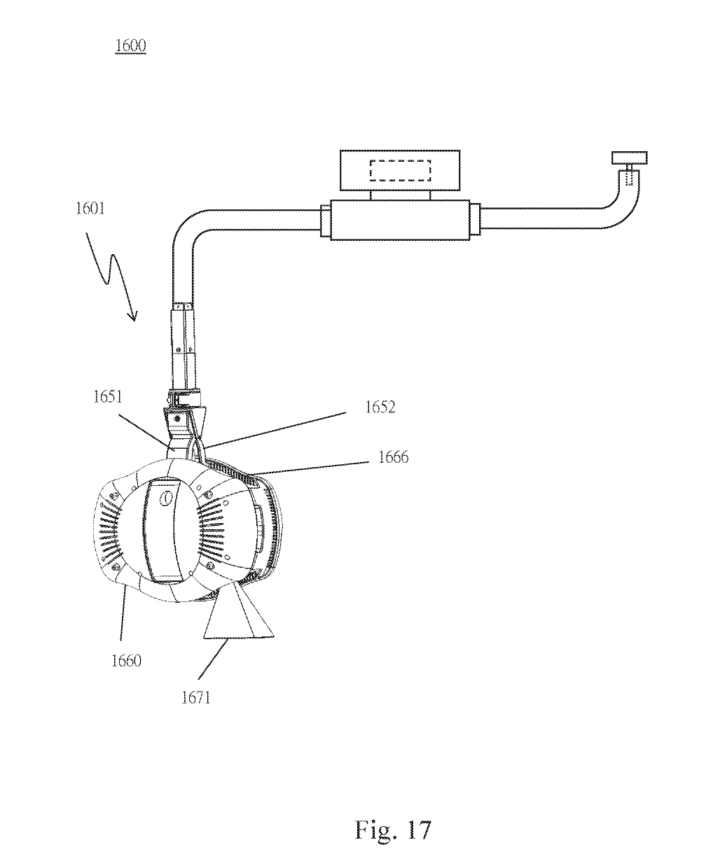

FIG. 17 depicts a projection device in accordance with a seventh embodiment of the invention, wherein the structure of the projection device 1600 is similar with that of the projection device 1500 of FIG. 16 and the descriptions thereof are omitted. FIG. 17 differs from FIG. 16 in that the location where the right engaging element and the left engaging element are connected to the main body is changed. In FIG. 17, the right engaging element 1651 and the left engaging element 1652 are connected to the rear groove 1666 of the main body 1660 so that the light 1671 containing the audio/video/image contents is projected downwards. It is noted that the projected audio/video/image contents are rectangular and still have a horizontal side longer than a vertical side. In FIG. 16, the right engaging element 1551 and the left engaging element 1552 are connected to the upper groove 1563 of the main body 1560 so that the light 1571 containing the audio/video/image contents is projected to leave the plane of FIG. 16.

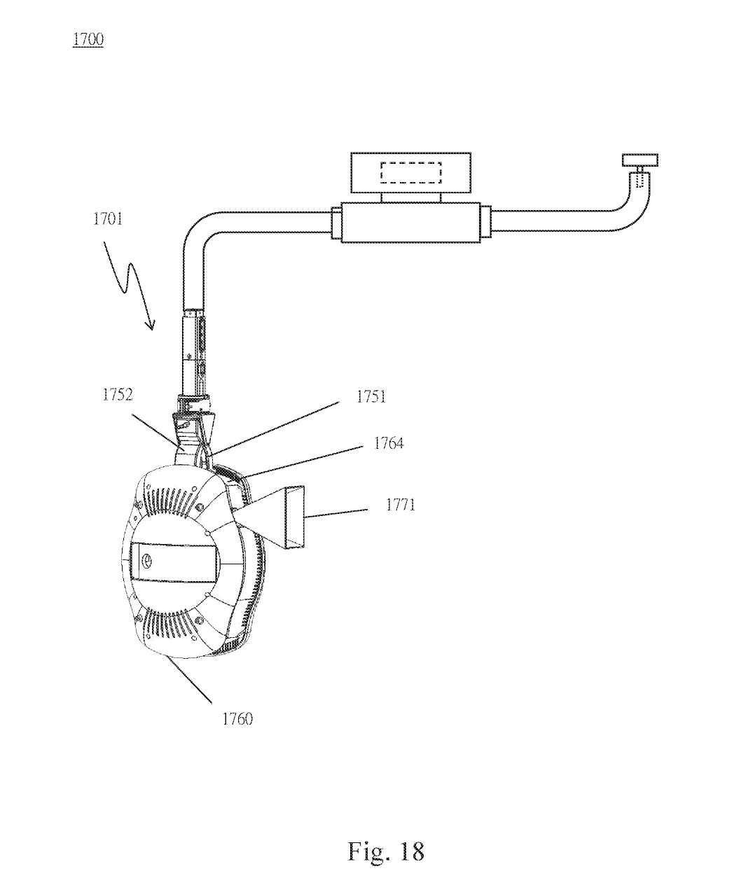

FIG. 18 depicts a projection device in accordance with an eighth embodiment of the invention, wherein the structure of the projection device 1700 is similar with that of the projection device 1500 of FIG. 16 and the descriptions thereof are omitted. FIG. 18 differs from FIG. 16 at the location where the right engaging element and the left engaging element are connected to the main body. In FIG. 18, the right engaging element 1751 and the left engaging element 1752 are connected to the right groove 1764 of the main body 1760 so that the light 1771 containing the audio/video/image contents is projected toward the right. It is noted that the projected audio/video/image contents are still rectangular but have a horizontal side shorter than a vertical side. In FIG. 16, the right engaging element 1551 and the left engaging element 1552 are connected to the upper groove 1563 of the main body 1560 so that the light 1571 containing the audio/video/image contents is projected to leave the plane of FIG. 16.

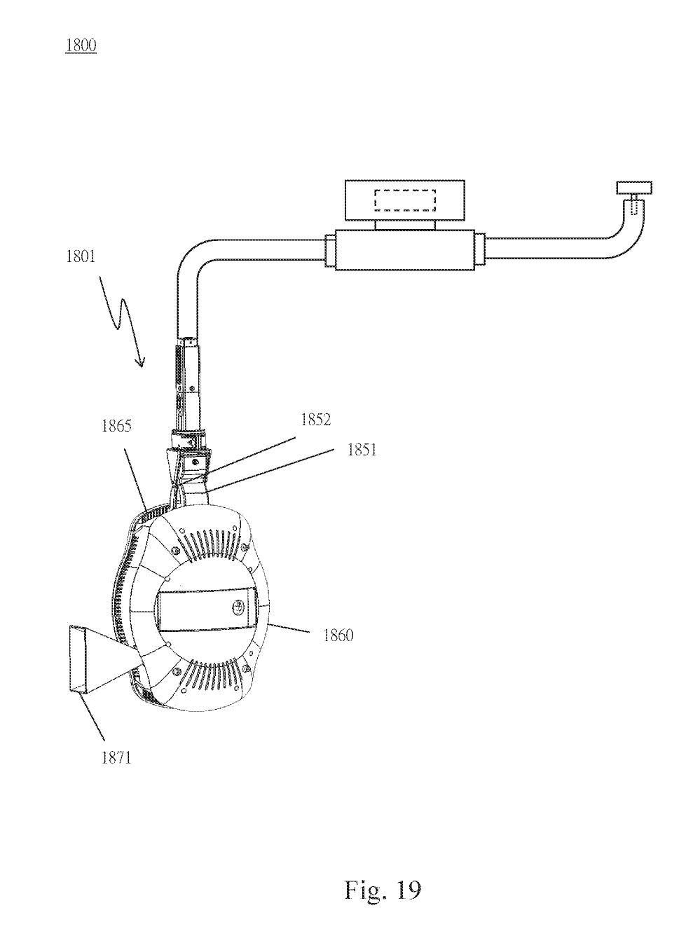

FIG. 19 depicts a projection device in accordance with a ninth embodiment of the invention, wherein the structure of the projection device 1800 is similar with that of the projection device 1500 of FIG. 16 and the descriptions thereof are omitted. FIG. 19 differs from FIG. 16 in that the location where the right engaging element and the left engaging element are connected to the main body is changed. In FIG. 19, the right engaging element 1851 and the left engaging element 1852 are connected to the left groove 1865 of the main body 1860 so that the light 1871 containing the audio/video/image contents is projected toward the left of FIG. 19. It is noted that the projected audio/video/image contents are still rectangular but have a horizontal side shorter than a vertical side. In FIG. 16, the right engaging element 1551 and the left engaging element 1552 are connected to the upper groove 1563 of the main body 1560 so that the light 1571 containing the multimedia images is projected to leave the plane of FIG. 16.

It is understood that the first rotatable element 1320 and the L-shaped supporting arm 1330 of the hanger support 1300 in the ninth embodiment can be respectively modified as a first rotatable element 820 of FIG. 9A and a linear supporting arm (not shown), and the linear supporting arm has two ends connected to the reception hole 823 of the first rotatable element 820 of FIG. 9A and the second rotational element 1340. Such modification belongs to the category of the invention.

It is understood that the housings connected to the main bodies in the above embodiments may be modified to have different shapes so that the projection devices have different appearances. Such modifications belong to the category of the invention.

It is understood that the projection devices of the above embodiments may be modified to include a receiver and a multimedia capturing device connected to the projectors. Such modifications belong to the category of the invention.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A hanger support, comprising:
a coupling portion configured to connect to a track for receiving power from the track;
a supporting arm connected to the coupling portion; and
a main body connected to the supporting arm.

2. The hanger support as claimed in claim 1, further comprising a first rotatable element connected to the coupling portion wherein the first rotatable element comprises a reception hole connected to the supporting arm, and the first rotatable element is rotatable to rotate the supporting arm, move the main body, and change a position of the main body.

3. The hanger support as claimed in claim 1, further comprising a second rotatable element connected to the supporting arm and the main body wherein the second rotatable element is rotatable to move the main body and change a position of the main body.

4. The hanger support as claimed in claim 1, further comprising a reflector connected to the main body.

5. The hanger support as claimed in claim 1, further comprising a third rotatable element and a reflector wherein the third rotatable element connected to the main body and the reflector, and the third rotatable element is rotatable to adjust a position of the reflector.

6. The hanger support as claimed in claim 1, further comprising an AC-DC converter disposed in the coupling portion, wherein the power from the track is AC power and the AC-DC converter is configured to convert the AC power to DC power.

7. The hanger support as claimed in claim 1, further comprising an AC-DC converter disposed in the main body, wherein the power from the track is AC power and the AC-DC converter is configured to convert the AC power to DC power.

8. The hanger support as claimed in claim 1, further comprising a housing connected to the main body.

9. The hanger support as claimed in claim 1, further comprising:
a first rotatable element connected to the coupling portion wherein the first rotatable element comprises a reception hole connected to the supporting arm, and the first rotatable element is rotatable to rotate the supporting arm, move the main body, and change a position of the main body:
a second rotatable element connected to the supporting arm and the main body wherein the second rotatable element is rotatable to move the main body and change the position of the main body;
a third rotatable element connected to the main body;
a reflector connected to the third rotatable element, wherein the third rotatable element is rotatable to adjust a position of the reflector;
an AC-DC converter disposed in the coupling portion, wherein the power from the track is AC power and the AC-DC converter is configured to convert the AC power to DC power;
a housing connected to the main body; and
a light source connected to the housing.

10. A projection device, comprising:
a hanger support as claimed in claim 1; and
a projector connected to the hanger support and configured to project audio/video/image contents.

11. The projection device as claimed in claim 10, further comprising a receiver and a multimedia capturing device connected to the projector, wherein the receiver is configured to receive a multimedia signal, the projector is configured to project audio/video/image contents of the multimedia signal, and the multimedia capturing device is configured to record a surrounding video, image and sound and transmit the recorded surrounding video, image and sound to a far-end device via a cable network or a wireless network.

12. The hanger support as claimed in claim 1, further comprising a balance arm connected to the coupling portion.

13. The hanger support as claimed in claim 12, further comprising:
a first rotatable element connected to the coupling portion wherein the first rotatable element comprises two reception holes connected to the supporting arm and the balance arm, and the first rotatable element is rotatable to rotate the supporting arm and the balance arm, move the main body, and change a position of the main body;
a top mount connected to the balance arm and configured to be rotated to adjust a length of the top mount protruding from the balance arm;
a second rotatable element connected to the supporting arm and the main body wherein the second rotatable element is rotatable to move the main body and change the position of the main body;
a third rotatable element connected to the main body;
a reflector connected to the third rotatable element, wherein the third rotatable element is rotatable to adjust a position of the reflector;
an AC-DC converter disposed in the coupling portion, wherein the power from the track is AC power and the AC-DC converter is configured to convert the AC power to DC power; and
a housing connected to the main body.

14. A hanger support, comprising:
a coupling portion configured to connect to a track for receiving power from the track;
a first rotatable element;
an engaging assembly; and
a main body comprising a top groove, a right groove, a left groove, and a rear groove, all of which comprise curved bottoms;
wherein the first rotatable element is connected to the coupling portion and the engaging assembly;
wherein the engaging assembly is connected to one of the top groove, the right groove, the left groove, and the rear groove;
wherein the engaging assembly is configured to slide along the top groove when connected to the top groove;
wherein the engaging assembly is configured to slide along the right groove when connected to the right groove;
wherein the engaging assembly is configured to slide along the left groove when connected to the left groove;
wherein the engaging assembly is configured to slide along the rear groove when connected to the rear groove;
wherein the first rotatable element is rotatable to rotate the main body.

15. A hanger support, comprising:
a coupling portion configured to connect to a track for receiving power from the track;
a first rotatable element connected to the coupling element;
a supporting arm connected to the first rotatable element;
a second rotatable element connected to the supporting arm;
an engaging assembly connected to the second rotatable element; and
a main body comprising a top groove, a right groove, a left groove, and a rear groove, all of which comprise curved bottoms;
wherein the engaging assembly is connected to one of the top groove, the right groove, the left groove, and the rear groove;
wherein the engaging assembly is configured to slide along the top groove when connected to the top groove;
wherein the engaging assembly is configured to slide along the right groove when connected to the right groove;
wherein the engaging assembly is configured to slide along the left groove when connected to the left groove;
wherein the engaging assembly is configured to slide along the rear groove when connected to the rear groove;
wherein the first rotatable element is rotatable to rotate the main body;
wherein the second rotatable element is rotatable to rotate the main body.

16. The hanger support as claimed in claim 15, further comprising a balance arm and a top mount, wherein the top mount connects to the balance arm, the top mount is configured to be rotated to adjust a length of the top mount protruding from the balance arm, and the first rotatable element comprises two reception holes connected to the supporting arm and the balance arm.

17. A projection device, comprising:
a hanger support as claimed in claim 14; and
a projector connected to the hanger support and configured to project audio/video/image contents.

18. The projection device as claimed in claim 17, further comprising a receiver and a multimedia capturing device connected to the projector, wherein the receiver is configured to receive a multimedia signal, the projector is configured to project audio/video/image contents of the multimedia signal, and the multimedia capturing device is configured to record a surrounding video, image and sound and transmit the recorded surrounding video, image and sound to a far-end device via a cable network or a wireless network.

19. A projection device, comprising:
a hanger support as claimed in claim 15; and
a projector connected to the hanger support and configured to project audio/video/image contents.

20. The projection device as claimed in claim 19, further comprising a receiver and a multimedia capturing device connected to the projector, wherein the receiver is configured to receive a multimedia signal, the projector is configured to project audio/video/image contents of the multimedia signal, and the multimedia capturing device is configured to record a surrounding video, image and sound and transmit the recorded surrounding video, image and sound to a far-end device via a cable network or a wireless network.
